(19) United States
(12) Patent Application Publication
(10) Pub. No.: US 2015/0050629 A1
(43) Pub. Date: Feb. 19, 2015

(54) SYSTEM AND METHOD FOR PROVIDING PHYSICAL AND MENTAL STIMULUS

(71) Applicants: David PEASE, Kitchener (CA); Geraldine PEASE, Kitchener (CA)

(72) Inventors: David Pease, Kitchener (CA); Geraldine Pease, Kitchener (CA)

(21) Appl. No.: 14/380,564

(22) PCT Filed: Feb. 25, 2013
(86) PCT No.: PCT/CA2013/050139

§ 371 Date: Aug. 22, 2014

Related U.S. Application Data
(60) Provisional application No. 61/602,871, filed on Feb. 24, 2012.

(51) Int. Cl. G09B 19/00

(52) U.S. Cl. CPC G09B 19/003
USPC 434/247

(57) ABSTRACT

A system and method for providing physical and mental stimulus in which both balancing and targeting are used simultaneously. The system includes: a balancing module, including: a platform to be mounted by a user; and a base assembly affixed to the platform for permitting the platform to move in at least one of pitch, roll, or yaw; at least one projectile; and a target console, including: a faceplate with at least one target shape at which the user may launch the at least one projectile; and a stand assembly for mounting the faceplate. In particular, the faceplate is mounted at an angle such that the at least one projectile bounces back at the user for the user to catch and reuse as a projectile.

### FIELD

The present disclosure relates generally to a system and method for providing physical and mental stimulus. More particularly, the present disclosure relates to a system and method for providing physical and mental stimulus through a balance stimulation and projectile targeting program.

### BACKGROUND

Precise balance, space-time decisions and live activity feedback are the building blocks of mental stimulation.

Preserving and enhancing the human balance system is an activity that can provide benefits to a person's health and wellbeing. Being able to navigate a human body in an upright position typically requires a large amount of a person's brain resources. Generally, when a person's balance system is placed in circumstances where exerted effort is required, as in controlled balance stimulation activities, the brain will place more resources at the disposal of the balance system. At that point, with more resources available, the brain may benefit from undertaking a constructive activity. One such constructive activity would be having the person partake in targeted projectile launching.

The ability to throw a projectile and hit a distant target for food, or for self-preservation, was likely an important survival skill for early man. Many brain neurons are utilized to undertake the launching of a projectile. The greater the distance required to launch the projectile, the likely greater number of brain neurons needed to support the activity. The brain structures that were originally developed to make this possible are also believed to be the brain structures that make language, intelligent thought and mathematical thought possible.

An important part of the balance stimulation and projectile launching processes is the feedback system. Feedback can take many different forms but the principle of cause and effect is the same. A successful projectile launching sequence causes the brain to operate in milliseconds and fractions of milliseconds. However, improvement in brain operation is believed to occur mor readily if immediate feedback is provided with regards to the outcome of the launching sequence and/or the balancing system.

Conventional systems and methods for providing physical and mental stimulus seem to rely on either physical stimulus or mental stimulus. Even if combined, for example, in a video game or the like, the experience tends to be virtual rather than real world.

Improving brain processing operations may result in improvements in balance, reaction time, hand-eye coordination, athletic performance, comprehension, thought processing, manual dexterity and academic capabilities. Therefore, there remains a need for providing mental and physical stimulation through a balance and projectile targeting program which may incorporate a feedback system.

### SUMMARY

It is an object of the present disclosure to obviate or mitigate at least one disadvantage of previous systems and methods for providing physical and mental stimulus.

According to a first aspect herein, there is provided a system for providing physical and mental stimulus, the system including: a balancing module, including: a platform to be mounted by a user; and a base assembly affixed to the platform for permitting the platform to move in at least one of, pitch, roll, or yaw; at least one projectile; and a target console, including: a faceplate with at least one target shape at which the user may launch the at least one projectile; and a stand assembly for mounting the faceplate. The combination of balancing and targeting is intended to provide both physical and mental stimulus to the user.

In a particular case, the base assembly may have a half-dome shape, wherein the flat-side of the half-dome is attached to the platform and the apex of the half-dome is towards the ground. In this case, the base assembly may further include a concave-shaped corral in which the base assembly is mounted for situations where a user may prefer the platform to be more stable.

Generally speaking, the at least one projectile will be sphere shaped and formed of a compound which can bounce.

In some cases, the at least one target shape may be a matrix of rectangles or a series of concentric circles. However, any appropriate shapes may be used.

In another particular case, the target console further includes indicators for notifying the user of system conditions. These indicators may also indicate at least one of the target shapes for the user to target. These indicators may also indicate a position of the platform or the target console may further include a display configured to indicate the position of the platform.

In another particular case, the stand assembly is configured to hold the faceplate at a predetermined angle in relation to the user. The predetermined angle is determined to allow the projectiles to bounce back to the user after being thrown at a target on the faceplate. In this case, the angle of inclination of the faceplate may preferably be adjusted by the user.

According to another aspect herein, there is provided a method for providing a physical and mental stimulus, the method including: balancing on a balancing mechanism; receiving a target on a target console at which to launch a projectile; launching the projectile at the target; and repeating the balancing, receiving and launching.

In a particular case, the target received may be one of a multiplicity of targets. In this case, the target received may be chosen at random from the multiplicity of targets.

In another particular case, the method may further include providing feedback to the user relating to the state of the balancing.

In yet another particular case, the method may further include providing feedback to the user relating to whether one or more previous launched projectiles hit or missed the target.

In yet another particular case, the method may further include catching the launched projectile upon rebounding back from the target console.

### BRIEF DESCRIPTION OF THE DRAWINGS

Embodiments of the present disclosure will now be described, by way of example only, with reference to the attached Figures.

FIG. 1 is a block diagram of an embodiment of the system for providing physical and mental stimulus.

FIG. 2 is a top view of the balance module according to an embodiment.

FIG. 3 is a front view of the balance module according to an embodiment.

FIGS. 4 and 5 are a plan view and front view, respectively, of the balance module according to a further embodiment.

FIGS. 6A and 6B are a front perspective view and front view of the target module according to an embodiment.

FIG. 7 is a flowchart of a method for providing physical and mental stimulus according to one embodiment.

FIG. 8 is a diagrammatic top view of the balance module according to an embodiment.

### DETAILED DESCRIPTION

Generally, the present disclosure relates to a system and method for providing physical and mental stimulus through a balance stimulation and projectile targeting program.

As per the research of Dr. Frank Belgau, balance stimulation activities may improve the brain functions of children with learning problems and make it possible for poor readers to develop into good readers. Balance stimulation may significantly improve the academic achievement, athletic ability, manual dexterity, and total performance of the average child. Balance stimulation may significantly expand the learning and thinking abilities of the highly gifted child or young adult, especially in mathematics. The streamlining and sharpening of brain functions that balance stimulation causes in the brain may lead to more efficient and productive operation of the brain.

Many adults work in environments that are stressful and damaging to their visual and postural systems. Balance stimulation may reduce or eliminate this damage and dramatically increase overall efficiency and productivity in all dimensions of their lives.

For many people, the stress of sitting in one place and looking at a flat computer monitor screen for long periods of the day diminishes the efficiency of various important brain elements. Dynamic balance stimulation activities may prevent permanent damage and improve performance at this kind of a task.

The neurobiologist William Calvin observed that many of the neural networks that are involved in language and speech are the same ones that primitive man utilized to throw a rock and hit a small animal. Calvin felt that the survival advantage of throwing from a distance provided a powerful driving force to push the development of the human brain. The brain structures that were originally developed to make humans the most versatile and efficient hunters on Earth became the brain structures that make language and mathematical thought possible. The brain structures a person uses for language, mathematics, and other thought processes may have been facilitated by the development of the throwing exercise.

As far as the timing function of brain neurons, the firing of an individual neuron is erratic. As the numbers of neurons in a neural network increases, however, the firing becomes more precise and stable. Accordingly, there is a relationship between the number of neurons in a network and the timing precision of the network.

When a hunter throws a rock at his quarry, his arm must move through a very precise, arc-shaped trajectory. If the rock is released too soon in the arc, it will fly over the top of the quarry; if it is released too late, it will hit the ground in front of the quarry. William Calvin calculated the launch windows for the release of a rock thrown at a quarry from a distance of four meters and eight meters. At four meters, the timing window is 11 milliseconds. At eight meters, it is 1.4 milliseconds. Calvin calculated that as the throwing distance increased from four to eight meters, the number of brain neurons required to meet the timing demands increased. If it took one million neurons to hit the target at four meters it would require sixty-four million neurons to hit it at eight meters. The increased brain resources required to meet the demands of the throwing act could serve to drive the brain to expand and develop. Additionally, as the precision level of an activity is increased, the number of brain neurons utilized to perform the activity similarly increases.

To hit a target, the arm and hand must execute a very precise trajectory through space. The throwing action of the arm and of every body part that moves in the throwing act changes the body's balance. Unless all of these changes are counter-balanced, the throwing trajectory will deviate and the projectile will miss the target. Accordingly, as the precision of the firing of the brain neurons increases as the throwing distance increases, likewise the balance precision necessary to support the throwing action also increases dramatically as the throwing distance increases.

Balance is an integral part of the throwing exercise. As someone seeks to throw a projectile, that person first must carefully determine its mass by holding it in his hand and moving it up and down. As he moves one hand, his other hand and other parts of his body also move to counter-balance the movement of the hand holding and moving the rock. As the person determines the mass of the projectile, the whole body acts as a multisensory balance or scale. Determining the mass of the projectile is a dynamic process. Moving the projectile adds an inertial component to the gravitational factor in figuring out the mass of the projectile. Motion activates more neural networks and increases the resolution of the measuring process.

Accordingly, balance plays a critical role in determining the mass of the projectile. Balance is a highly integrated multisensory process. Before the person picked up the projectile, he located it visually, looked at it, and estimated it's mass. Under visual guidance, he focused and positioned his body and then reached down and picked up the projectile. As he picked up the projectile, the force of gravity acting on the projectile created pressure on the skin of his hands and fingers where tactile sensors are activated. Picking up the projectile changed the person's center of gravity, and to restore it he had to shift his hips and arms.

Changing the body's center of gravity changes the distribution of pressure on the bottom of each foot. The tactile sensors on the bottoms of the feet detect this change also. Picking up the projectile involves expending energy in the muscles and joints of the body as well as changing the tension of each individual muscle bundle. The kinesthetic sensors in the muscles and joints detect these changes. Picking up the projectile involves some head movement. The very delicate sensors in the vestibular sensory system detect this motion in space. A head motion is detected also by the visual system. All of this information from the tactile, kinesthetic, vestibular and visual systems is simultaneously transmitted to the various brain structures. It is integrated and processed, critical segments are stored in memory, and proper actions and reactions are executed.

A person attempting to throw a projectile will use his tactile senses to record the direction and velocity of the wind blowing on his hair, face and ears. He calculates the distance to the target and the mass of the projectile. The person computes the amount of energy that must be expended to overcome the inertia of the projectile and move it through space at the desired velocity to his intended target. He computes the exact trajectory the projectile must follow to reach and hit his target, taking into consideration the effect the wind might have on the path the projectile follows. He computes the counter-balancing motions that his body must execute in order to maintain the stability that is necessary to execute the precise trajectory the arm must follow through space to carry out the throwing action. The plan is stored in his short-term memory. The person executes the planned action. The kinesthetic system acts, but each action is sensed as it occurs and sent to a memory bank. The tactile changes that occur on the bottom of each foot and in the hand holding the projectile when the projectile is launched are sensed and sent to memory. The changes in head position and head movements are recorded by sensors in the muscles and joints of the neck, and the vestibular system and are sent to memory. They are also sensed by the visual system which tracks the projectile through space, and this data is sent to memory. If the person misses his target, the whole operation is reviewed. The planned action is compared with the executed action to detect execution glitches. If none are detected, the original plan is reviewed and probable difficulties are examined. Any difficulty that is detected in the original plan is sent to memory to be utilized in the next operation. If the person hits his intended target, his review of the operation reinforces structures that he used for throwing.

The process of throwing a projectile is a multisensory symphony conducted by the balance system. A key to the total operation is precise timing of the throwing, counter-balancing, and sensory processes involved. All of the sensory and motor neural networks that are involved in the balancing, counter-balancing and throwing action must operate in phase or in a common temporal structure. Each person utilizes a unique combination of sensory processes to accomplish the throwing task.

There is redundancy in the balance system because of the overlapping nature of the various sensory processes involved in the dynamic balance functions. However, the vestibular operations in the throwing act may be much more important than they first appear.

The vestibular operations provide the greatest share of the timing structures involved in orientation in three-dimensional space and of the coordination of the visual, kinesthetic, tactile and vestibular sensory procedures involved in the throwing action. The temporal integration of all the senses involved is important for the throwing actions. In order to execute the throwing action with the precision required to hit a small target at a distance, an extraordinarily high degree of balance must be maintained throughout a throwing sequence. It is logical that coordinating and controlling the timing of all sensory functions and motor actions involved may be a primary role of the balance system.

Efficient posture and balance in the throwing act require continuous information relative to the motion and position of all body parts, especially the head and eyes and the arm executing the throwing action. The eyes must be accurately fixed on a target in space even when the body and head are moving. To accomplish this task, feedback information from the head is independent of that from the eyes. The eyes can move in relation to the body and the body can move in relation to the visual field. For this to operate the position and movement of the eyes can be based on non-visual cues. The vestibular system of the brain and inner ear provide the information relative to the motion and position of the head and eyes and the non-visual cues necessary for the positioning and movement of the eyes. The posture system provides the foundation and spatial reference structure for the eyes. To the brain, visual space is a dynamic three dimensional inertial structure in a gravitational field.

When a person looks at a target, throws a projectile, and hits it, he innately computes the space visually and calculates the mass of his projectile. He begins by calculating how much energy must be expended to overcome the inertia of the projectile to accelerate it to a necessary velocity to move it through space to his target. The stone must reach its target with sufficient force to hit the target and achieve the desired result. The mass of the target and the mass of the projectile are relative. To the brain, the distance from the target, the mass of the target, the velocity of the projectile and the velocity of the target if it is moving are all fundamentally dynamic inertial structures in an unchanging gravitational field. Dynamic movement is temporal and spatial. The brain's inertial systems are not innate. They are developed through activity. A person who has had proper early stimulation and a great deal of experience will have a higher resolution inertial system than one who has had very little early stimulation and experience. The person who has developed a very high resolution inertial structure will throw more efficiently than a person with an inadequate brain system.

The brain's three dimensional inertial structures may represent the foundation of mathematical abilities. A very high resolution three dimensional dynamic inertial structure is probably necessary for high level achievements in mathematics. Many sports and games that modern children play likely do not involve enough precise targeting. If the child's brain structures have not been stimulated and developed through natural movement and targeting, it may hinder a child's mathematical abilities.

The primary balance sensory organs are located in the inner ear. The vestibular portion of the inner ear is made up of two important structures, a pair of sack-like swellings, the otolith organs, called the saccule and utricle and three more or less mutually perpendicular, directionally sensitive semicircular canals. Sensory receptor cells in these organs respond to accelerated movement of the head or to changes in acceleration due to altering the position of the head in space. The response of each component is different. Each component also responds to different types of acceleration. The three semicircular canals lie in different planes that are perpendicular to one another. Because of this arrangement in three dimensional space, the semicircular canals detect angular acceleration of the head in any of these three directions (pitch, yaw and roll).

The arrangement of the three semicircular canals and their tremendous sensitivity simplifies the brain's computing requirements for developing a three-dimensional spatial structure or making sense of three-dimensional space. The otolith organs detect linear acceleration when the head moves in space. They are also important for determining the position of the head relative to gravity. Information from both the semicircular canals and the otolith organs is sent through the vestibular portion of the nerve to the vestibular nuclei in the brain stem and to the vestibular portion of the cerebellum. Different segments of the vestibular nuclear complex connect in a highly specific manner with the motor nuclei of the extraoccular muscles. They also connect in a highly specific manner to the spinal cord. The entire system functions to keep the body balanced and to coordinate head and body movements. An extraordinary property of this system is that it keeps the eyes accurately fixed on a target even when the head and body are moving through space. The vestibular sensory system can detect and react to accelerations or decelerations as fine as 0.01 degree/sec2.

The foot, which plays a special role in balance, has an important sensory role. As a person walks or runs, the foot is constantly sensing and adjusting to changes in the surface of the ground, making the foot both a sensor and an actor in the balance-counter-balancing process. The bottom of the foot and sensors in the muscles and joints of the bones of the foot are very sensitive to changes in pressure and position. The foot is also very sensitive to slight changes in position on the ground and adjusts to them. At the same time, it senses those changes, and provides the brain with the information that is critically important to the actions of the body in space.

Throwing a rock at a target is believed to be a very sophisticated demonstration of balance functions. To create a program that stimulates and develops balance, and the three-dimensional perceptions and cognitive processes that are rooted in balance, the program should account for postural balance. As well, the program should account for the balancing and counter-balancing functions that permit us to launch projectiles at targets in the distance.

As stated by Professor William Calvin, accurately throwing a projectile at a target is a task that may seem difficult. If you let loose of the projectile too early, before the launch window was reached, the projectile arched too high and went too far. If you let loose too late, the path was too straight and hit the ground below the target. If a person moved closer, or used a larger target, the launch window lasted longer and so was easier to attain. Motor neurons that are too noisy will not allow a person to settle down to controlling projectile release precisely enough to stay within the launch window.

For throwing at a rabbit-sized target (10 cm high, 20 cm deep) from about a car length away (4 meters), the launch windows averaged out at about 11 milliseconds wide. This may be the inherent noise in single motor neurons while the motor neurons are in their self-paced mode. Spinal motor neurons are simply being commanded to fire at the right time by descending commands from motor cortex and not making the decisions within the basins of attraction in spinal cord itself. The spinal motor neurons might be noisy on their own but under the command of the brain, they might be precise repeaters and the precision might be upstream.

Accordingly, in order to benefit from these improvements in brain operation, a person would benefit from participating in a system that provides mental and physical stimulus through balancing and throwing exercises. A person partaking in these exercises may be able to gain additional benefits if the exercises are undertaken with physical real-world components and if the person receives live activity feedback.

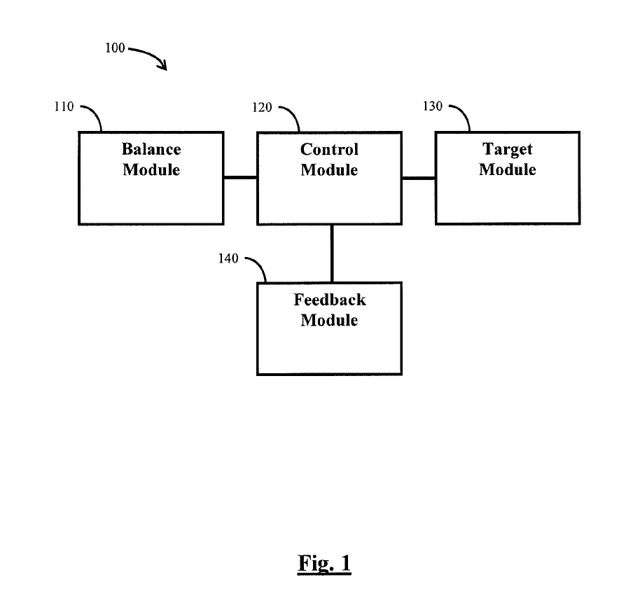

FIG. 1 is a block diagram of an embodiment of the system 100 for providing physical and mental stimulus. The system 100 includes a balance module 110 for providing balance stimulation, a control module 120 for controlling the targeting and balance sequences, a target module 130 for providing a target for projectile launching, and a feedback module 140 for providing feedback regarding the balance stimulation and projectile launching. The modules may be combined where appropriate such that, for example, the control module 120 and feedback module 140 may be physically co-located with the targeting module 130.

The balance module 110 provides balance stimulation for the user. Balance stimulation is achieved whenever a person's balance system is performing in excess of its standard day-to-day functions. As an example, standing or performing specific exercises on a controllable unstable surface.

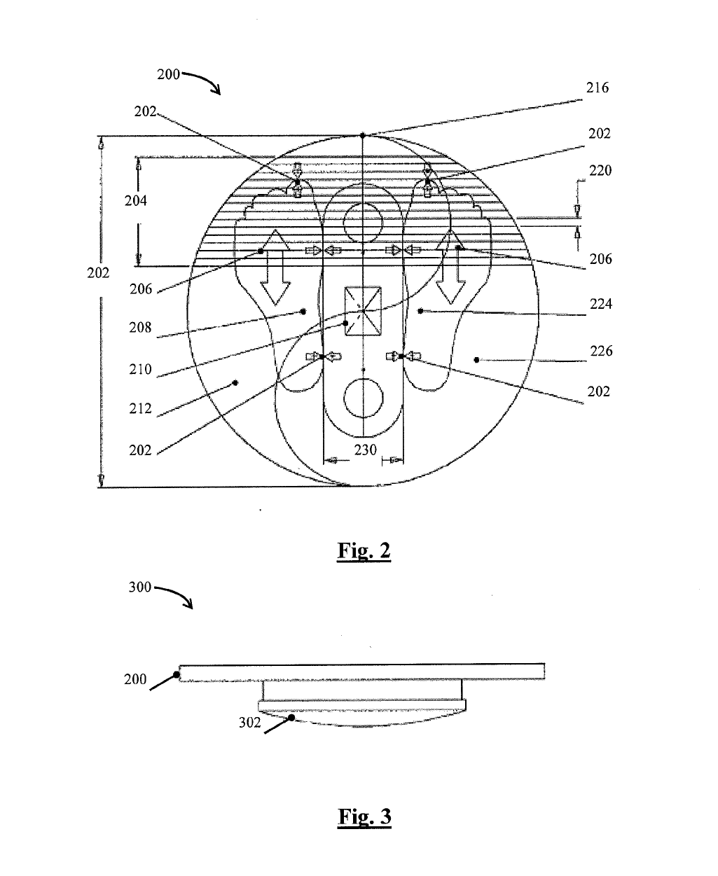

FIG. 2 illustrates one embodiment of the balance module 110, which provides a balancing exercise for a user. The balance module 110 includes a balance platform 200 for the user to stand on and a base assembly 300 which makes the balance platform 200 inherently unstable. The balance platform 200 can be made from a number of materials. The material should be strong enough to withhold a full adult's weight while being light enough to be easily moved and maneuvered. Such material might be, for example, plywood. In the present case, the balance platform 200 has a diameter 202 of 45 centimeters. In further cases, the balance platform 200 can have larger or smaller diameters to meet the requirements of the intended users, such as a smaller diameter platform 200 intended for children.

The platform 200 design may have a Yin Yang background 226 showing two average-sized footprints 208. The design also includes a front to rear centerline 216 which passes through the center of gravity of the platform 200. The footprints 208 are placed on either side of the centerline 216. Equally spaced lines 220 run perpendicular to the centerline 216 for front to rear foot adjustment. In this case, the grid pattern 204 covers approximately one third of the platform 200 surface. Small arrows also show initial foot placement 218, with large arrows 206 for foot adjustment. This design is intended to instruct the user by giving an approximate location for proper foot placement, such that the user may achieve all-round balance while standing on the platform 200. In further embodiments, the platform may include designs that are designed for kneeling, or sitting, or lying on the platform, although these postures may have less impact on physical and mental stimulus.

The balance module 110 also comprises a base assembly 300 that is attached to the underside of the balance platform 200. The base assembly 300 allows the balance platform 200 to require the user to perform balance control from all directions; for example, it allows the balance platform 200 to pitch, roll, or yaw in any direction. As illustrated in FIG. 3, the present embodiment includes a base assembly 300 which is a domed shape 302. In further cases, the shape or materials may change to provide varying levels of balancing difficulty. For example, having a smaller radius may provide for more difficult balancing, or having a softer material may provide for easier balancing. In further embodiments, the base assembly 300 may have different shapes, such as being a polygonal shape, being a circular shape with depressions, or the like.

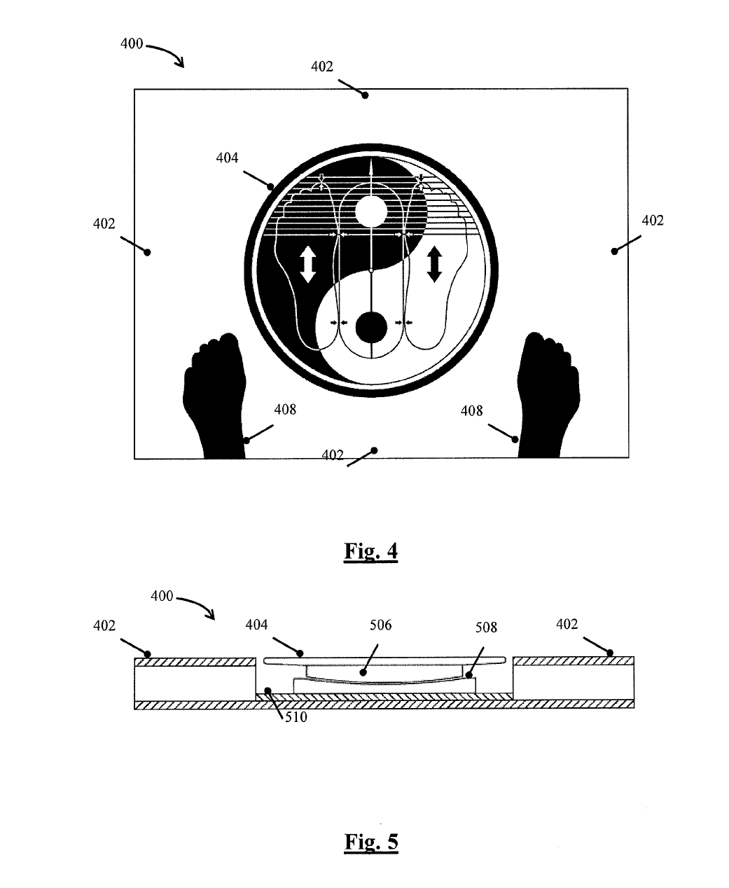

FIGS. 4 and 5 are a top view and side view, respectively, of a further embodiment 400 of the balance module 110. The base assembly 506 may still comprise a dome shape; however, the base assembly 506 may be mounted inside a matching concave-shaped corral 508 to form a ball and socket configuration. Additionally, an immobile standing surface 402 may surround the balance platform 404 and corral 508 area. Footprints 408 may be placed on the immobile standing surface 402 to guide the user on where to stand. This embodiment may be configured to prevent lateral movement in some directions, or allow the user to withhold participating in the balancing exercise if he or she chooses. In a further embodiment, the balance module 110 may not include a concave-shaped corral 508, but still include a balancing platform 404 with a dome-shaped base assembly 506 on a flat surface 510 surrounded by an immobile stand surface 402. This case would allow the immobile standing surface 402 to act as the stepping off point toward the balancing platform 404.

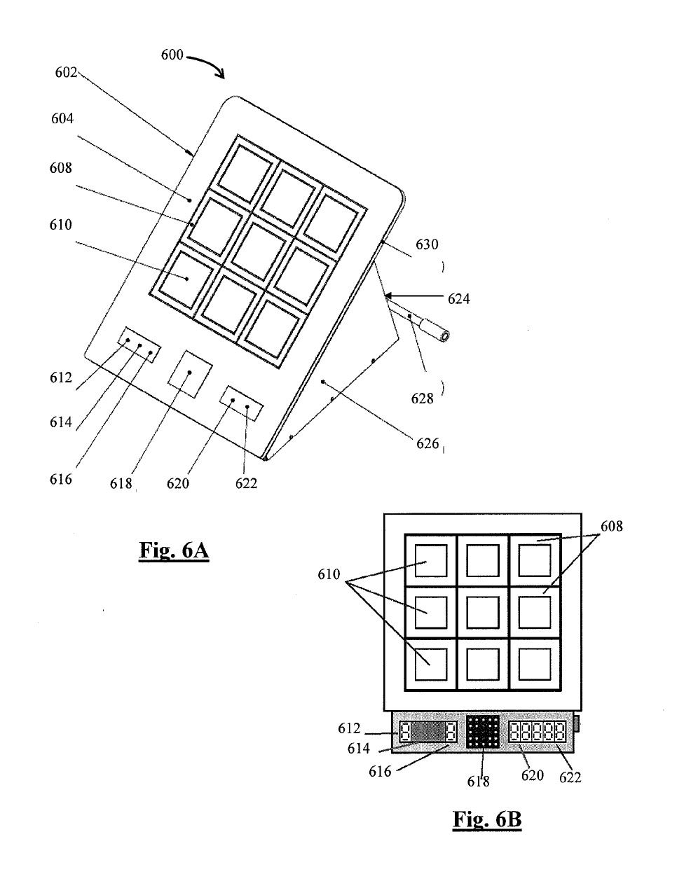

The target module 130 is used to provide projectile launching stimulation for the user. FIGS. 6A and 6B illustrate a front perspective view and front view, respectively, of one embodiment of the target module 130. The target module 130 includes a target console 600 and a projectile (not shown). The target console 600 provides the target acquisition part of the projectile launching exercise for the user. The target console 600 includes a faceplate 602 and a stand assembly 624.

The target console 600 may be made from a number of materials but the material should be strong enough to withstand a hard-thrown projectile, but light enough to be easily moved by the user. An appropriate material may be, for example, stainless steel or aluminum. In the present embodiment, the target console 600 has a rectangular faceplate 602 but other shapes may be used.

The projectile (not shown) should be made out of a material that can bounce off a hard surface, have enough weight to maintain a consistent trajectory, but soft enough not to be painful to catch. An appropriate material for the projectile may be an elastomer such as rubber. In the present embodiment, the projectiles are a sphere shape with a 45 millimeter diameter. There may be a waist pouch, bag, pocket, or sack to hold the projectiles when they are not being launched.

The stand assembly 624 may consist of support plates 626 and an adjustable turnbuckle 628. The support plates 602 are fastened to the faceplate 602 and allow the faceplate 602 to be directed towards the user at an inclined angle. The adjustable turnbuckle 628 allows the angle of the faceplate 602 to be adjusted by the user. In a further case, the angle of the faceplate 602 may be adjusted electronically by the user or automatically by a computing device.

The faceplate 602 includes targets 610, non-target dead zone areas 604 and multiple game or feedback indicators. In the present embodiment, the targets 610 consist of a three-by-three matrix of rectangles. The targets 610 measure 6.25 centimeters by 6.25 centimeters and include a pressure-detecting sensor (not shown). The dead zone areas 604 measure 5.5 centimeters wide around the perimeter of the targets 610. In further embodiments, the targets 610 may consist of, for example, different arrangements of rectangles or concentric circles. In another embodiment, the faceplate 602 can be an electronic screen, such as a touchscreen, with virtual targets that may be dynamic and changing.

The feedback indicators on the faceplate 602 may include game selection 612, clock/timer 614, game status 616, balance crosshair 618, score indicator 620, and statistics indicator 622. Additionally, there may be target indicators 608 located around each target 610. The game selection 612 indicator is used to display the type of game chosen. Some of the game variations will be described below. The clock/timer 614 indicator is used to display a countdown of time remaining in the game or to display the total time played. The game status 616 indicator is used to display aspects of the current game, such as the round number or player number. The balance crosshair 618 indicator is used to display to the user the status or orientation of the balance module 110. The balance crosshair 618 is designed to be in direct line-of-sight of the user such that the user can receive immediate and constant feedback on the balance exercise. The score indicator 620 is used to display the current game score. The statistics indicator 622 is used to display derivative information regarding the score, for example, previous scores, score improvement percentages, or average scores.

The target indicators 608 are used to display information about each target. The target indicators 608 may inform the user which target to try to hit, which target to avoid, which target was hit, or which target was missed. The target indicators 608 may inform the user through the use of colored lights or other visual displays.

In further embodiments, the game/feedback indicators may include audible indicators (not shown) that are used to provide audible information to the user. The audible indicators may use different sounds to inform the user of various game conditions, for example, the start of a game, the end of the game, a milestone in the game, a hit target, a missed target, or the like.

The majority of the game status information is communicated to the user through the game status indicator 616. In one embodiment, while waiting at the game select menu screen (discussed below), the indicator will display a top to bottom scrolling pattern of lights. Once a game has been selected, the indicator will display a countdown to the start of the game (providing the user with enough time to get into the proper position), counting down from 9 to 0. Once the game has begun, the indicator will display a clockwise rotating pattern of lights, and will continue to do so until the game finishes.

The target indicators 608 may also produce a variety of light patterns, communicating the overall status of the device or the occurrence of a significant event. For example, while the unit is first starting up, a flashing light pattern will appear and remain on the target board until wireless communication has been established and the balance module 110 has completed its connection.

Once a game has been selected, the target indicators 608 will illuminate red and green lights on all targets, then one by one return each to neutral. In a further case, this may work in tandem with the game start count down in the game status indicator 616.

When a game has ended, the target indicators 608 will alternatively flash its lights, indicating success, before flashing the startup light pattern again and returning to game selection.

The feedback module 140 is used to provide feedback regarding the balance module 110 and the target module 130. Live activity feedback may allow a user to obtain greater performance improvement. For the balance module 110, the feedback module 140 may provide information to the user regarding the position and orientation of the balance platform 200. Sensors (not shown), such as accelerometers or gyroscopes, may be located in the balance platform 200 or the base assembly 300. These sensors are used to track the balance conditions of the balance platform 200, for example, the total pitch, roll, yaw or displacement of the platform 200. The feedback module 140 may then relay this information to the user through the control module 120 which may display the information using the balance crosshair 618. As the balance crosshair shows the balance conditions to the user, the user can use this feedback to then adjust his balance on the balance platform 200. In further cases, the balance conditions may be displayed using a different representation, such as a three-dimensional rendering of the balance module 110. In a further embodiment, the feedback module 140 may include haptic feedback in the balance module 110, for example, a vibration or sound is transmitted to the user when the balance platform 200 approaches an out-of-balance state.

Since the targeting process requires physical commitment, any movement voluntary or involuntary, while standing on the balance platform 200 will cause an out of balance condition. The feedback module 140 can then respond accordingly using the balance crosshair 618, and perhaps other out of balance warnings, to notify the user to control his or her posture or feet position in order to achieve proper balance.

For the target module 130, the feedback module 140 may provide information to the user regarding the results of the projectile targeting exercise. The feedback module 130 will examine whether a specific target or targets 610 have been hit by the projectile. If the feedback module 140 detects that a target 610 has been hit, the feedback module 140 will use the control module 120 to convey the feedback result to the user. Such communications to the user may include, an increase in the score indicator 620, a light color associated with a hit (such as green) being displayed in the target indicator 608 for the associated target 610, or an audible sound with a positive connotation. An audible sound with a positive connotation could be, for example, the sound of an old-time manual cash register. Similarly, if the feedback module 140 detects that a target 610 was missed, the feedback module 140 will interact with the control module 120 to convey the feedback result to the user. Such communications to the user may include, a decrease in the score indicator 620, a light color associated with a miss (such as red) being displayed in the target indicator 608 for the associated missed target 610, or an audible sound with a negative connotation. An audible sound with a negative connotation could be, for example, a sporting event buzzer. Additionally, if there is a missed target 610, the feedback module 140 may show the user where the projectile hit the faceplate 602 so the user can make adjustments for their next projectile launching.

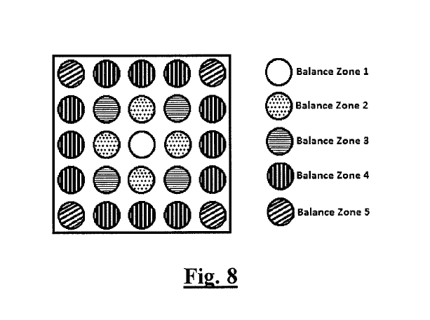

In further embodiments, the feedback module 140 may be connected with the score counter 620. In one case, as illustrated in FIG. 8, the balance platform's 602 orientation may be divided into 5 separate zones. Each zone carries a different weighting. When a projectile successfully hits a target, the exact orientation of the platform is captured and the score counter 620 is modified accordingly. The weighting is such that superior posture and balance are given a higher score. In a further case, proper balance and posture will receive an upward adjusted score even if the target is missed.

The following is an example of a scoring system that is proportionally tied to how well the user can retain his or her balance while launching projectiles. This type of scoring system is intended to reward good balance by the user. As illustrated in FIG. 8, the balance platform 200 orientation has been divided into 5 separate zones. Each zone weighted differently depending on whether an increase scoring event or a decrease scoring event occurs. When the projectile successfully strikes a target 610, the exact orientation of the balance platform 200 is captured and the scoring action is weighted accordingly. When striking a target 610 that results in an increase scoring event, the score would be increased by:

Balance Zone 1—10 points

Balance Zone 2—7 points

Balance Zone 3—5 points

Balance Zone 4—3 points

Balance Zone 5—1 point

Conversely, when striking a target that results in a decrease scoring event, the score would be decreased by:

Balance Zone 1—1 point

Balance Zone 2—3 points

Balance Zone 3—5 points

Balance Zone 4—7 points

Balance Zone 5—10 points

The control module 120 is used to control the targeting and balancing sequences. Specifically, the control module 120 communicates with the balance module 110, target module 130 and feedback module 140 in order to run the targeting and balancing exercise games. The control module 120 may be located on a general-purpose programmable computing device, microprocessor, specialized computing device, or other type of electronic device.

The communication between the control module 120 and one or more of the balance module 110, target module 130, or feedback module 140 may be through wired or wireless means. The wireless communication means may use radio, Wi-Fi™, Bluetooth™, or the like. The wireless communication means should be capable of allowing multiple devices to be played in close proximity without fear of cross signal interference.

The control module 120 controls the targeting and balancing games which are designed to provide balance and projectile launching stimulation for the user. The balance games can come in many different variations, but in essence the games are used to provide a target for projectile launching while the user may be performing the balancing exercise. The games provide a challenging and stimulating exercise for a person's balance system and projectile launching ability in a controlled and entertaining environment. Selected embodiments of the targeting and balancing games are described below.

Prior to starting any of the games, proper system set up should be ensured. The balance module 110 may be placed at any distance from the target module 130. Generally, at the outset, the balance module 110 may be placed approximately 2 meters from the target module 130. As the user's skills improve, the distance between the balance module 110 and the target module 130 may be increased. When the distance is increased, the angle of inclination of the faceplate 602 should be adjusted such that the projectiles typically rebound back to the user at a reasonable height to be caught. Both the balance module 110 and the target module 130 should be placed on a high-friction surface, for example, a carpeted floor.

The following describes one embodiment for the startup sequence of the system 100. The user turns on both the target module 130 and the balance module 110, ensuring the balance platform 200 remains flat and still. While communication is being established between the modules, the target indicators 608 will flash a repeating pattern of green and red lights. Once communication is established, the game select menu (discussed below) will become available. The balance module 110 will then perform an automatic tare (that is, attempt to zero itself) and will use this zero point as a reference for the balance crosshair 618 indicator calculations. For the best results, the balance module 110 should be placed at the same position it will be located throughout its use. The balance module 110 should be left untouched until wireless communication has been successfully established and the automatic tare has been completed. The balance crosshair in the balance indicator 618 will locate itself to the bottom right corner of the balance indication display during this period. Once the tare function has completed, the balance crosshair will relocate itself to the center of the balance indicator 618. At this point, it is permissible for the user to mount the balance platform 200. In order to re-tare the balance module 110, the power can be switched off and then on again or a reset switch may be included.

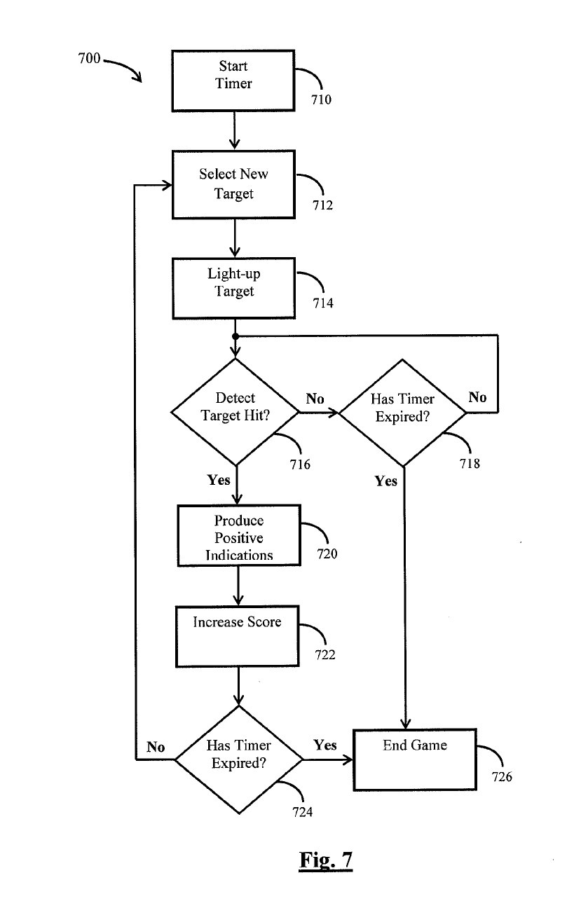

FIG. 7 is a flowchart of a method for physical and mental stimulus (balance and targeting game) according to one embodiment. At 710, the game is commenced and the timer is started. At this point, the user may mount the balance platform 404. A new target 610 is selected 712 at random. The selected target 610 is lit up 714 or otherwise identified such that the target 610 can be ascertained by the user. The user will then attempt to launch projectiles at the selected target 610. After striking the inclined faceplate 602, the projectile should bounce back to the user such that the projectile can be caught. The game detects 716 if the target has been hit by one of the projectiles.

If there has been a hit, the game produces 720 positive indications for the user. The positive indications may include the target indicator 608 displaying a certain color and an audible sound playing which has a positive connotation. The score counter 620 is then increased 722 to reflect a positive target hit. Then the timer is checked 724 to ascertain whether it has expired. If the timer has expired, the game ends 726. If the timer has not expired, a new target is randomly selected 712.

If the game does not detect a hit at 716, then the timer is checked 718 to ascertain whether it has expired. If the timer has not expired, the game repeats the detection 716 for a hit on the selected target. If the timer has expired, the game ends 726.

In another embodiment, the game of FIG. 7 includes detection of projectiles that missed the selected target 610. When a missed projectile is detected, the game communicates the miss to the user using, for example, an appropriately colored target indicator 608 or an audible sound with a negative connotation. The game may also indicate to the user where the missed projectile struck the faceplate 602. Additionally, any projectiles that missed the selected target 610 could be deducted from the score counter 620. A score increase may provide positive live activity feedback to reinforce neural networks, while a score decrease may provide negative live activity feedback which promotes brain recalibration for the next throw.

In further embodiment, the game of FIG. 7 includes a structured selection of targets instead of the randomly selected 712 target. The structured selection of targets may include attempting to hit specific targets 610 in a certain order, for example, row-by-row from left to right, column-by-column top to bottom, or an ‘X’ pattern. In another case, the structured selection of targets 610 may require hitting every target only once, and may require hitting the targets 610 in a certain order or hitting the targets 610 in any order.

In another case, the game of FIG. 7 ends when a certain score 620 is obtained rather than when a timer expires. Instead of starting a timer at 710, the game can start a clock that displays the playing time. As well, instead of checking whether the timer has expired at 718 and at 724, the game may check whether a certain score 620 has been obtained.

In a further case, there may be a “no hit” penalty which adjusts the score counter 620 downwards. While playing any of these games, it is beneficial to keep a consistent throwing pace. In some cases, there may be a “no hit” penalty timer (not shown) constantly running in the background that is constantly monitoring all of the targets for a detected strike. Should enough time pass without a recorded detected strike, the “no hit” penalty will subtract a 1 from the users total score before resetting the timer. A strike to any target, in any state (neutral, green or red), will result in a reset of the penalty timer and the score will be safe from penalty.

In another embodiment, the game of FIG. 7 may include further exercises when catching the projectile. Catching exercises may include, for example, catching and throwing with alternating hands, catching the projectile and then passing it around the person's body, or catching and throwing with only one hand.

In a further embodiment, the game of FIG. 7 can be modified for two or more users. The new target selection 712 may further include a selection of which user is to launch the projectile. The score counter 620 may include separate scores for each user. Each user may use his or her own balance module 110, or all users may share the use of one balance module 110. In a further case, each user can have their own system 100, whereby the control modules 120 of each user's system are in wireless communication. The control modules 120 can communicate various system conditions, for example, the clock/timer 614 value or the score counter 620 value. This multiple system configuration may allow for competitive scoring techniques to motivate the separate users. The wireless communication means may use radio, Wi-Fi, Bluetooth, or the like.

In a further embodiment, the type of game selected may be inputted by the user by depressing an associated target. Once the startup sequence is completed and the balance board has started, or after a reset function has been performed, the game select menu will become available. At this point, the user may select their desired game mode by hitting or depressing the associated target. In the present example, there are four families of games available to be played; Fill the Board (Games 1-3), Chase the Target (Games 4-6), Circuit (Games 7-8), and Waterfall (Game 9). Each family of games includes its own set of strategies and techniques in order to achieve success.

In a further case, the game of FIG. 7 can include a reset function (not shown). The reset function can be activated at any point during game play, resetting the target indicators 608, score counter 620 and control module 120 to the game select menu. This is the preferred method for resetting the game, rather than toggling power to the system 100, as there is no wait time to re-establish the wireless connection, and no wait time while the balance board performs an automatic tare. This will wipe the scores and return the unit to its startup state, waiting at the game select menu.

In a further embodiment, the system 100 includes an enclosure (not shown) around the components of the system. The enclosure may prevent projectiles from escaping the immediate area and possibly becoming lost. The enclosure should be large enough to not interfere with the balancing or projectile launching exercises. The enclosure should be configured such that it will prevent projectiles from escaping and may consist of, for example, netting, mesh, screen, intertwined wire, bars, or the like.

### Exemplary Game Types

The following details describe exemplary game instructions for nine different game types according to an embodiment of the system 100. References to the color of a target denote the color of the target indicator 608 associated with that target 610, whereby neutral refers to a white, yellow or no-color-displayed target indicator 608.

Game 1—Fill the Board:

Game 1 is the first in a series of games, belonging to the “Fill the Board” family. The objective is to convert all of the neutral targets to green targets. Once the game starting countdown reaches zero, the game begins. All targets begin in the neutral state. When a neutral target is struck by a projectile, it will turn into a green target and cause a score increase. A second hit to an already struck target will have no effect other than resetting the no hit penalty timer. The game ends when all targets have been converted to green targets.

Game 2—Fill the Board II—Toggle Mode:

Game 2 is the second in a series of games, belonging to the “Fill the Board” family. The objective is to convert all of the neutral targets to green targets. Once the game starting countdown reaches zero, the game begins. All targets begin in the neutral state. When a neutral target is struck by a projectile, it will turn into a green target and cause a score increase. Since Game 2 is in toggle mode, a second hit to an already struck target will cause a score decrease and cause the target to become red. Striking a red target results in a score increase and the target will toggle back to green. The game ends when all targets have been converted to green targets.

Game 3—Fill the Board III—Toggle+Devious Mode:

Game 3 is the third game in the series of games belonging to the “Fill the Board” family. The objective here is to convert all of the neutral targets to green targets. All targets begin in the neutral state. When a neutral target is struck by a projectile, it will turn into a green target and cause a score increase. A second hit to an already struck target will cause a score decrease and cause the target to become red. Striking a red target results in a score increase and the target will toggle back to green. Additionally, after a set duration of time has expired, one randomly selected green target will toggle to a red target. This random event may not affect the score. The game ends when all targets have been converted to green targets.

Game 4—Chase the Target:

Game 4 is the first game belonging to the “Chase the Target” family. The objective is to chase the randomly appearing green targets around the board until a high enough score is obtained. One randomly selected target will begin as a green target while all other targets begin in the neutral state. When the green target is struck by a projectile, it will turn back into a neutral target, cause a score increase and a new randomly located green target will then be displayed. Striking a neutral target will have no effect other than the resetting of the no hit penalty timer. The game ends when a predetermined score has been achieved.

Game 5—Chase the Target II—Roaming Mode:

Game 5 is the second game belonging to the “Chase the Target” family. The objective is to chase the randomly appearing green targets around the board until a high enough score is obtained. One randomly selected target will begin as a green target while all other targets begin in the neutral state. When the green target is struck by a projectile, it will turn back into a neutral target, cause a score increase and a new randomly located green target will then be created. In roaming mode, throughout the game, after a set duration of time has expired, the green target will turn back into a neutral target and another new random green target will take its place. Striking a neutral target will have no effect other than the resetting of the no hit penalty timer. The game ends when a predetermined score of 300 or greater has been achieved.

Game 6—Chase the Target III—Roaming+Devious mode:

Game 6 is the third game belonging to the “Chase the Target” family. The objective is to chase the randomly appearing green targets around the board until a high enough score is obtained. In devious mode, the game startup is slightly different because one randomly selected target will begin as a green target and one randomly selected target will begin as a red target. All other targets will begin in the neutral state. When the green target is struck by a projectile, it will turn back into a neutral target, cause a score increase and a new randomly located green target will then be displayed. When the red target is struck by a projectile, it will turn back into a neutral target, cause a score decrease and a new randomly located red target will then be displayed. Each of the red and green targets will roam as noted above.

Game 7—Circuit:

Game 7 is the first game belonging to the “Circuit” family. The objective is to convert all of the neutral targets to green targets. All targets begin in the neutral state and are constantly on the move. For example, the targets are all continually rotate clockwise, at a set time cadence, around a stationary center target. When a neutral target is struck by a projectile, it will turn into a green target and cause a score increase. A second hit to an already struck target will have no effect other than resetting the no hit penalty timer. The game ends when all targets have been converted to green targets.

Game 8—Circuit II—Toggle mode:

Game 8 is the second game belonging to the “Circuit” family. Due to toggle mode, when a green target is struck by a projectile, it will cause a score decrease and cause the target to become red. When a red target is struck by a projectile, it will result in a score increase and the target will toggle back to green. The game ends when all targets have been converted to green targets.

Game 9—Waterfall:

A random sequence of targets will appear across the top row of the target matrix. After a set duration of time has elapsed, these targets will shift from the top row to the middle row, and a new random sequence of targets will appear across the top row. The targets will continue to “trickle” downwards in this manner. Striking any type of target (neutral, green or red) will only modify the score and will not modify the target type. Striking a green target will increase the score, striking a red target will decrease the score and striking a neutral target will only reset the no hit penalty timer. The game ends when a predetermined score is achieved.

### Technical Details

The following technical details describe one embodiment of the systems and methods described herein. This example is provided merely as an illustration and it will be understood that not all elements described are required in all embodiments of the system and method to be claimed.

A Picdem LCD 2 demo board, populated with a PIC 18F85J90 chip, is responsible for controlling the operation of the score display, the game status indicator, the game indicator, the target type identification lights and struck target detection, as well as the majority of the game calculations and process. Live balance feedback signals are generated within an accelerometer located within the balance module 110. The accelerometer generates analog voltages indicative of its orientation in regards to both the X and Y axis, which is repeatedly polled and transmitted by the balance platform mounted transceiver. The two wireless transceiver units, MRF24J40MA's, used in conjunction with two PICDEM Z demo boards—populated with PIC 18F4620 chips, are responsible for the balance detection, balance calculations, balance BCD communication and balance indication.

Main unit: the main unit, containing the PIC 18F85J90 chip, operates as follows: once the Main program is accessed, the program will first check to determine if the initialization complete flag has been set. If not, the Initialization subroutine is called:

Initialization Subroutine: Once called, this subroutine is responsible for the specific calibration of the chip as required by the written program, with respect to the control registers within the chip architecture. This routine first writes to the LCD control register, disabling the LCD display on the PICDEM LCD 2 demo board, along with all LCD segments. Next the Oscillator register is written to, setting the oscillation frequency to 8 MHz. The Analogue to Digital Control register (ADC) is then written to, enabling the analogue inputs, clearing the result registers and clearing the execution bits within the control register. The Interrupt control register is then configured, enabling high priority interrupts, setting interrupt behavior and clearing any interrupt flags. The Timer control register is written to, setting a timer to act as a consistently repeating interrupt source. The I/O registers are written to next, setting the LAT, TRIS and PORT bits as necessary to achieve proper operation for each I/O port and its assigned function. Now, with the registers configured explicitly, all necessary game variables used throughout the program are reset. Finally, the Lightflash subroutine is called to give a visual indication that the unit has started properly. (The Lightflash subroutine simply moves through a sequence of I/O Latch configurations, with delays between each step of the sequence, responsible for turning on and off the source pins, sourcing the target type indicating LED's.) With the initialization sequence complete, an initialization complete flag is set, allowing the program to continue.

The Main program next checks for the current status of the menu level variable. Upon start up and upon each game completion or reset, the menu level variable will be reset to zero, leading the program to enter the Game Select subroutine.

Game Select Subroutine: The Game Select subroutine first checks to see if wireless communication has been properly established between the transceivers (as detailed in the Transceiver program). This check is performed by polling the three pins responsible for BCD communication between the wireless receiver and the main board. If wireless communication has been successfully established, the wirelesscommactive flag is set and the subroutine can proceed to the next menu level (level one), else the wirelesscommactive flag is cleared and the Lightflash routine is called once more to indicate that communications have not yet been established.

The Lightflash routine will be called repeatedly until wireless communication has been successfully established. The flashing pattern of lights act as an indicator to the user, indicating that the game device is still in its start-up phase.

With the wirelesscomactive flag set, and the menu level variable set at level 1, the Game Select routine proceeds to source the Target LED's in the game select menu pattern (lighting the rows of targets in alternating colors), to be displayed on the target touch screen. The routine now begins to scan each of the target screens one at a time, through repeated calls to the ExecuteADC subroutine (see ExecuteADC subroutine description), waiting to detect a strike to one of the targets. Once a strike is detected and registered, the identity of the struck target is fed into a “switch, case, break” comparison to then set the game identity variable, set the game start countdown variable and to clear any score that may remain within the scoring registers from a previously played game. Once accomplished, the menu level variable is raised to 2 and the Game Select subroutine is exited.

Now that the wireless communication has been established and the desired game to play has been selected, the Main program will enter a “while” loop containing the specific game program (instructions and calculations) responsible for creating a unique challenge. Once this loop has been entered, the Game Status Indicator begins to count down from 9 to 0, while displaying a splash animation of lights on the target touch screen, giving the user time to mount the balance platform and ready oneself before the game commences. The splash animation consists of lighting all target touchscreens at once and removing them one at a time, in coordination with the game starting countdown. Once the game has either been completed or reset, the program will re-initialize, and reset the menu level variable to 0.

The Game Status Indicator and the Game Indicator work together communicating the status of the gaming device to the user. The Game Indicator will display a value of “0” whenever no game is being played and the device is waiting in the menu levels. Once a game has been selected, this indicator will display the numerical value of the current game being played. The Game Status Indicator, aside from providing the game starting countdown, is responsible for relaying the state of gaming device to the user. When waiting in the menu levels, this indicator will display a pattern of lights rotating in a clockwise formation. Once a game has been selected, and the game starting countdown finished, the indicator will then display a cascading pattern of lights falling from top to bottom, indicating that a game is currently in play.

While all these instructions are being executed, there are several other subroutines being called. The Interrupt subroutine (ISR), for example, is called frequently and is the driving force behind display control. The scoring subroutines are also called upon regularly throughout game play to either positively or negatively affect the score; these routines must check on the balance orientation of the balance platform at the moment the target was struck to ensure accurate scoring.

Interrupt: Each time the Interrupt subroutine is called, a series of game variables become incremented by one. These variables are used throughout the program as a method of keeping time and triggering specific events to take place at set intervals, as the interrupt occurs at regular consistent timed intervals.

The Interrupt is responsible for controlling the score displays and game indicators, providing clear indication as to game progress. In order to minimize pin and power usage, the display segments can be multiplexed together so that one pin may source all common segments at once. It is the combined action of setting the appropriate source pins, and activating the appropriate drain to display the correct value in the correct location at the correct moment in time. As only one drain may be active at a time, this switching should occur very rapidly to ensure that all values are present, seemingly at once, and that the switching is unperceivable by the human eye.

Once the game variables have been incremented, the Interrupt subroutine switches off all of the 7 segment display drains (score displays, game indicator and game status indicator). Next, the score display control variable is switched in a “switch, case, break” comparison to determine which placeholder value (ones, tens, hundreds, etc. . . . ) is to be displayed next. Within this “case”, the appropriate value for the selected display location is loaded into the score display variable and the Segment Display subroutine is called.

Segment Display Subroutine: The segment display subroutine simply turns off all segment sourcing pins. Next, it compares the value to be displayed with the sets of unique sourcing configurations until a match is found. The necessary sourcing pins are turned on, sourcing the desired pattern of segments so that the proper value can be displayed. Once accomplished, the Interrupt routine can continue forward.

Now that the correct sourcing pins are active within the score display/game indicators, the appropriate drain is activated, displaying the correct value in the correct location. With the display modifications finished, the score display control variable is incremented (will rollover when exceeding range), to ensure that the next call to the Interrupt subroutine will result in the next placeholder value being displayed. Before exiting the ISR and returning to the point of interruption within the program, the interrupt timer accumulator registers are reloaded, the interrupt flag is cleared and the global interrupts are re-enabled.

Games: Once the game selection has been decided and the game starting countdown finished, the game itself can begin. All games operate in a similar fashion, it is only the light patterns and occasionally the resulting action of a struck target that differ between games.

When first entering a new game, the program first sets up the target lights on the target touch screen, as required by the specific game mode—this can mean toggling all the targets off, on, a random selection of red and green, etc. Once set, the game will enter the game loop, which simply waits until a strike to a target has been detected, and then performs the appropriate scoring calculation and whatever else action may be required (toggling of target type, etc. . . . ), depending on the specific game mode.

While in the game loop, the program may check for a “no hit condition” (no target has been struck, either correct, incorrect or neutral within the time frame given—this time is reset with every strike to a target). Should the “no hit condition” be true, than the No Hit Decrease subroutine is called to decrement the users score by one point, else, the program continues on. Next, the ExecuteADC subroutine is called.

ExecuteADC Subroutine: When called, the current channel being scanned by the analogue to digital conversion component (ADC) is incremented to the next analogue channel being utilized by a target. This ensures that each time this subroutine is called, it scans just one channel at a time, ensuring that the correct target is identified struck, yet because this routine is called so often and so rapidly, each target is read within a very short period of time. Once the correct channel is loaded into the ADC component, it executes its conversion and waits upon the results before returning to the routine from which it was called. After executing the ADC, the Check4reset subroutine is called.

Check4reset Subroutine: This subroutine is executed after every ExecuteADC subroutine call because it checks for the reset situation. This routine checks for target 1 and target 9 (top left and bottom right targets, respectively) to be pressed simultaneously for a set duration of time. If this condition holds true for the duration of time required to activate the reset sequence, than the target touch screen will flash a new light pattern to indicate that this command has been received, the score will clear itself and the Main unit will undergo a reinitialization. Otherwise, the game simply resumes.

From here, provided a reset condition had not been met, the program will compare the result of the ADC conversion with the minimum threshold value to indicate a target strike. Should the value surpass this threshold, the program will go on to use a “switch, case, break” comparison, switching the ADC channel that was most recently scanned, and determine the appropriate course of action depending on the game type and the conditions met. Should the struck target be one which causes a scoring action to occur, the appropriate scoring subroutine will be called (increase score/decrease score). The game will continue on in this manner until either the game ending conditions have been met, the game ending score has been achieved or the reset condition is met.

Scoring: As this game may utilize a weighted scoring system, dependent on the orientation of the balance board at the time of the struck target, the wireless receiver can be polled upon every score altering event. In one case, there are five unique balance zones which the orientation of the balance board can fall under, each weighted differently.

When a scoring event occurs (either increment or decrement, depending on the current game being played) the appropriate scoring routine is called (Increase Scoring or Decrease Scoring). These subroutines have near identical operation, with the only difference being an inverted weighting system and subtraction as opposed to addition. When the routine is first called, a check balance operation bit is set (0 for increments, 1 for decrements) and then the check4balance subroutine is called.

Check4balance Subroutine: Once called, the subroutine polls the wireless receiver to determine which balance zone the balance platform was orientated within at the time of the strike. This is communicated via three pins indicating the balance zone through BCD values. Based on this value, the score factor is weighted accordingly.

Good balance to a correct target=high incrementing score factor

Good balance to an incorrect target=low decrementing score factor

Poor balance to a correct target=low incrementing score factor

Poor balance to an incorrect target=high decrementing score factor

With the score factor now properly loaded, the check4balance subroutine ends and the scoring subroutine resumes.

The existing score is now modified by this score factor (either incremented or decremented). Once the new total score has been calculated, the score is broken into its individual placeholder values, to enable rapid display changes in the Interrupt subroutine. The scoring subroutine is now finished and the current game resumes.

Dead Zones: There are “dead zones” located throughout the target board. Small dead zones surround each of the target touchscreens, ensuring a clear visual separation of the individual targets. These dead zones exist to prevent multiple struck targets with a single throw, to allow LED illumination used to identify the state of each target and to encourage the user to concentrate their aim on one specific target, rather than a blind toss hoping to trigger one of a few potential targets.

A dead zone is also located along the perimeter of the target touch surface. This dead zone provides plenty of surface area for the thrown projectile to strike and bounce back towards the user, as well as the confidence required to aim for the outside targets without the fear of striking the edge of the target touch surface and losing the projectile to a sideways bounce.

These dead zones may have no effect on the operation of the program such that a strike to one of these zones will not reset the “no hit condition” timer.

Random Target Generation Subroutine: The Random Target Generation has two main subroutines; Random Green Target and Random Red Target. These two subroutines both first call upon the Random Number Generation subroutine, which will output a value between 1 and 9. This random number represents the target to be modified within the random target subroutines. The Random Green Target generation subroutine will only produce green targets that will overtake a neutral target. The Random Red Target generation subroutine, however, has two modes. One mode will cause a random red target to overtake only green targets, the other mode causes a random red target to overtake only neutral targets.

Rotate Target Subroutine: The Rotate Target subroutine causes the current state and orientation of the target touch screen targets (lighting pattern) to shift by one in a counterclockwise direction, leaving the center target untouched. It accomplishes this by moving the status of the first target into temporary variable for storage. It then copies the status of the 2nd target to the 1st, the 3rd target to the 2nd, etc. until all targets have been shifted in this manner. It then reloads the temporary variable storing the target status into the final target and the rotation is complete.

Waterfall Target Subroutine: The Waterfall Target subroutine is responsible for creating a cascading flow of randomly generated targets. Whenever called, this subroutine will first clear the entire lower row of targets on the target touch screen. It will then duplicate the status of the middle row of targets to the lower row, and then duplicate the status of the top row of targets to the middle row. The subroutine then generates a random value between 0 and 12. Using this randomly generated value, the subroutine will utilize a “switch, case, break” comparison and generate the randomly assigned pattern along the top row of the target touch screen.

Transceivers: The two transceiver units, utilizing the MiWi™ P2P stack, are used in unison, one as a transmitter—transmitting the raw data as read from the accelerometer chip mounted within the balance platform, the other as a receiver—receiving the accelerometer data, performing a series of calculations to convert the precise balance orientation of the balance platform into a value usable by the main game program. Upon start up, both of these units complete their initialization sequences and then attempt to establish wireless communication with one another.

Transmitter: Once the wireless communication has been established, the transmitter will continually scan the accelerometer, executing an Analogue to Digital Conversion on both the X-axis and Y-axis inputs. Once these values have been scanned, they are immediately sent to the Receiver for analysis. This process will continue indefinitely until either power is lost or the wireless communication link is broken.

Receiver: Upon start up, the program will first check for the initialization complete flag. If the flag is found to be reset, then the program will call upon the initialization subroutines. Four initialization subroutines are executed; Board Initialization, Console Initialization, P2P Initialization and a task specific initialization routine (setting appropriate I/O bits, resetting of variables, tuning the oscillator, etc. . . . ). Once these are complete, the initialization complete flag is set.

Now with all components initialized, the receiver unit will attempt to establish a wireless communication link with the transmitter. This is accomplished by first performing an active scan of all available channels. The optimal channel is then selected; all channels are scanned for energy and the channel with the least amount of noise is returned. Once the device has been set to run on the optimal channel, the “Enable New Connection” and “Create New Connection” subroutines are called upon. When a connection is firmly established, an LED toggles on the receiver, indicating success.

Once the initialization has been completed and the wireless communication has been established, the program will enter the main loop and the balance platform will immediately perform an automatic tare function. To accomplish this, the program will take ten unique samples of the x-axis and y-axis incoming values and determine the average incoming value of each. These two average values will serve as the new “zero” point and the threshold limits used to determine co-ordinate locations will be calculated relative to these new values.

The receiver takes all of the incoming raw orientation data and passes it through a series of equations, which will output a stabilized, usable value. This value is then passed through a series of limit comparisons, which determine the equivalent X and Y co-ordinate location to be displayed on the Balance Indication Display in the form of crosshairs. These co-ordinates are then sent through a cascading set of “switch, case, break” comparisons to combine the two co-ordinates into one value, representative of the co-ordinate location. Utilizing only one value simplifies and shortens the process of generating a crosshair pattern on the Balance Indication Display, as well as simplifies the process of determining the correct Balance Zone in which the crosshair currently resides and transmitting this data, via BCD signals, to the Main unit.

Balance Indication Subroutine: The Balance Indication subroutine works much in the same manner as the Interrupt routine on the Main unit. The subroutine utilizes a balance indication display control bit, which is incremented upon each call (until it rolls over), used to multiplex the Balance Indication Display, as well as to break up the load of calculations each cycle. Each run through this subroutine will turn off the currently activated column drain before calling the Balance Display subroutine.

Balance Display Subroutine: This routine utilizes the single value representation of the balance co-ordinate, as well as the balance indication display control bit, by means of switching them through a cascading set of “switch, case, break” comparisons. Once it has found a match, it will set up the necessary row sourcing pins (as determined by which column drain will be activated next and the current location of the crosshair) before returning to the Balance Indication subroutine.

Once back in the Balance Indication subroutine, the next column is set to drain and the multiplexing of the crosshairs continues on in this manner. Before every display cycle (one cycle is considered having all drains switched on at least once) the Balance Capture subroutine is called. As a cycle begins anew, the current balance position is called and stored to be used throughout the entire cycle. This ensures consistency between the visible crosshairs in the balance indication display and the weighted scoring factor.

Balance Capture Subroutine: The Balance Capture subroutine utilizes the single value representation of the balance co-ordinate. It switches this value through a “switch, case, break” comparison and will output the appropriate three wire, BCD signals, communicating to the main board, the balance zone the crosshair currently resides within for scoring purposes.

At the end of this subroutine, the program completes a basic check to determine if the incoming values are repeating themselves. Should the program receive the exact same value for either the x or the y incoming values thousands of times consecutively, then the wireless communication will be considered disconnected and attempts will be made to re-establish a connection.

In the preceding description, for purposes of explanation, numerous details are set forth in order to provide a thorough understanding of the embodiments. However, it will be apparent to one skilled in the art that these specific details are not required. In other instances, well-known structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope of the disclosure.

What is claimed is:

1. A system for providing physical and mental stimulus, the system comprising:
a balancing mechanism, comprising:
a platform to be mounted by a user; and
a base assembly for permitting the platform to, at least one of, pitch, roll, or yaw;
at least one projectile; and
a target console, comprising:
a faceplate with at least one target shape at which the user may launch the at least one projectile; and
a stand assembly for mounting the faceplate.

2. The system of claim 1, wherein the base assembly comprises a half-dome shape, wherein the flat-side of the half-dome is attached to the platform and the apex of the half-dome is towards the ground.

3. The system of claim 2, wherein the base assembly further comprises a concave-shaped corral in which the base assembly is mounted.

4. The system of claim 1, wherein the at least one projectile is sphere shaped.

5. The system of claim 1, wherein the at least one projectile is comprised of a compound which can bounce.

6. The system of claim 1, wherein the at least one target shape is a matrix of rectangles.

7. The system of claim 1, wherein the at least one target shape is a series of concentric circles.

8. The system of claim 1, wherein the target console further comprises indicators for notifying the user of system conditions.

9. The system of claim 8, wherein the indicators indicate at least one of the target shapes for the user to target.

10. The system of claim 1, wherein the target console further comprises a display configured to indicate the position of the platform.

11. The system of claim 1, wherein the balancing mechanism and the target console are in wireless communication.

12. The system of claim 1, wherein the stand assembly holds the faceplate at a predetermined angle in relation to the user.

13. A method for providing a physical and mental stimulus, the method comprising:
balancing on a balancing mechanism;
receiving a target on a target console at which to launch a projectile;
launching the projectile at the target; and
repeating the balancing, receiving and launching.

14. The method of claim 13, wherein the target received is one of a multiplicity of targets.

15. The method of claim 13, the method further comprising providing feedback to the user relating to the state of the balancing.

16. The method of claim 13, the method further comprising providing feedback to the user relating to whether one or more previous launched projectiles hit or missed the target.

17. The method of claim 13, the method further comprising catching the launched projectile upon rebounding back from the faceplate.
